(19) United States
(12) Patent Application Publication
(10) Pub. No.: US 2009/0318135 A1
(43) Pub. Date: Dec. 24, 2009

(54) SYSTEM AND METHOD FOR INDICATING SIGNAL INTENSITY OF MOBILE PHONE

(75) Inventors: YI-FANG WU, Tu-Cheng (TW); QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen (CN); HON HAI PRECISION INDUSTRY CO., LTD., Tu-Chen (TW)

(21) Appl. No.: 12/330,573

(22) Filed: Dec. 9, 2008

(30) Foreign Application Priority Data
Jun. 23, 2008 (CN) 200810302278.9

(51) Int. Cl. H04W 24/00

(52) U.S. Cl. 455/425

(57) ABSTRACT

A signal intensity indicating method for a mobile phone. The method includes assigning a plurality of signal points equidistantly around a circle, recording a position of each signal point while rotating the mobile phone, calculating a signal intensity of each signal point when an antenna of the mobile phone points to a direction consistent with the signal point, and comparing the signal intensities corresponding to the signal points to determine a signal point having the greatest signal intensity and recording the position of the signal point.

### BACKGROUND

1. Technical Field

The present disclosure relates to systems and methods for indicating signal intensity of mobile phones.

2. General Background

Mobile phones are becoming necessary communication tools in people's daily life. Typically, signal intensity signs are shown on screens of mobile phones to indicate current signal intensity during communication. Conventionally, the signal intensity is classified in several grades and are presented on the mobile phone screen in several longitudinal signs with different lengths. The longest sign presents the greatest signal intensity. However, when the mobile phone is in a different position, the signal intensity is different. In a typical signal intensity indicating method, the signal intensity between two adjacent signal intensity grades is indistinguishable. Therefore, it is difficult to accurately identify the position of the mobile phone where the signal intensity is greatest.

What is needed, therefore, is a system and a method for indicating the greatest signal intensity of a mobile phone.

### BRIEF DESCRIPTION OF THE DRAWINGS

FIG. 1 is a top view of one embodiment of a mobile phone with a system for indicating signal intensity.

FIG. 2 is a block diagram of one embodiment of a system for indicating signal intensity of the mobile phone.

FIG. 3 is a flow chart of one embodiment of a method for indicating signal intensity of a mobile phone.

FIG. 4 is a flow chart of another embodiment of a method for indicating signal intensity of a mobile phone.

### DETAILED DESCRIPTION OF THE EMBODIMENTS

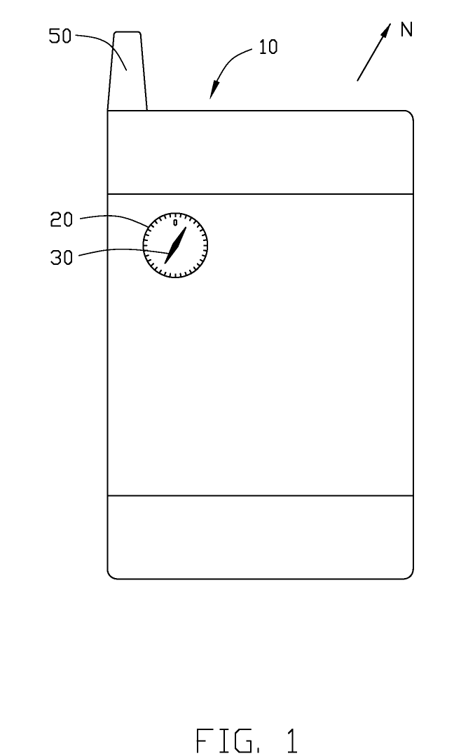

Referring to FIG. 1, one embodiment of a system for indicating a signal intensity of a mobile phone 10 during communication, includes a compass 20 and a pointer 30 always pointing to a north direction positioned on the mobile phone 10. An antenna 50 is positioned at a top corner of the mobile phone 10 for receiving communication signals. A plurality of equidistant points may be formed around the compass 20. For example, the north direction indicated by the pointer 30 on the compass 30 is adopted as a reference direction of the system. When the antenna 50 of the mobile phone 10 points to the north direction, a point at a top of the compass 20 overlapped by the pointer 30 is determined as a zero position. A program for indicating the orientation direction where the signal intensity of the mobile phone is greatest is configured in a microprocessor of the mobile phone 10.

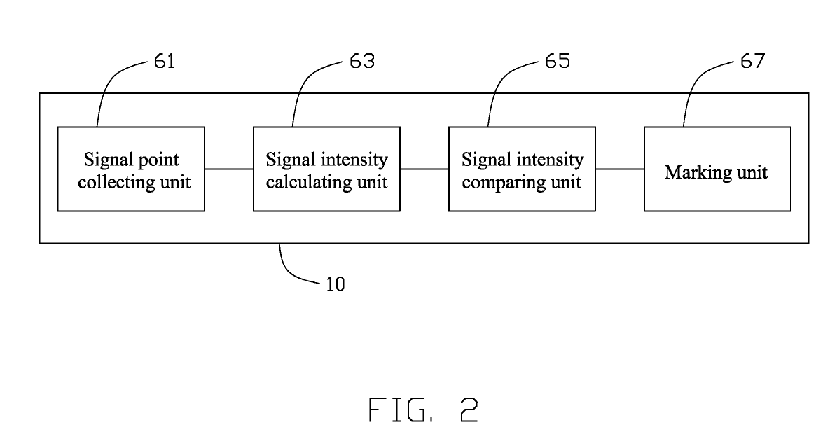

Referring to FIG. 2, the system further includes a signal point collecting unit 61, a signal intensity calculating unit 63, a signal intensity comparing unit 65, and a marking unit 67.

When in use, the mobile phone 10 is rotated 360 degrees with the compass 20 facing up. The signal point collecting unit 61 sets a plurality of signal points equidistantly around a circle and records the orientation of each signal point relative to the north direction. The signal intensity calculating unit 63 calculates the signal intensity corresponding to each signal point. The calculated results are stored in the microprocessor of the mobile phone 10. Then, the calculated results are compared to one another by the signal intensity comparing unit 65 to determine the signal point having a greatest signal intensity. The marking unit 67 identifies a signal direction having the greatest signal intensity and records and marks the orientation of the signal point having the greatest signal intensity on the compass 20.

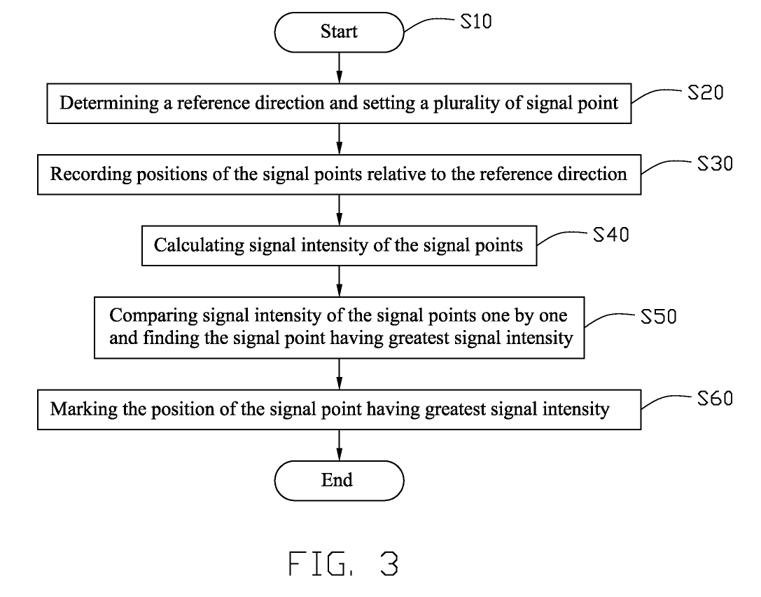

FIG. 3 is a flowchart illustrating one embodiment of a method for indicating the signal intensity of the mobile phone 10. Depending on the embodiment, certain of the steps described below may be removed, others may be added, and the sequence of steps may be altered.

In step S10, powering on the mobile phone 10.

In step S20, determining the reference direction according to the compass 20, and sets a plurality of signal points equidistantly around a horizontal circle.

In step S30, recording the positions of the signal points relative to the reference direction. In the present embodiment, the signal points are collected from a position consistent with the north direction. When the antenna of the mobile phone is moved around in a circle or a predetermined angle, such as every 10 degrees, the signal point collecting unit 61 records a position of a corresponding signal point. Thus, there is a plurality of signal points recorded by the signal point collecting unit 61. In the example above, there would be 36 signal points.

In step S40, calculating signal intensity of each signal point when the antenna of the mobile phone 10 moves to a position aligned with one of the signal points. [0014] In step S50, comparing signal intensity of each signal point and finding the signal point having the greatest signal intensity the signal intensity comparing unit 65 compares the signal intensity of each signal point and records the position of the signal point having the greatest signal intensity.

In step S60, marking the position of the signal point having the greatest signal intensity so as to indicate the communication orientation of the mobile phone having the best communication quality. In one embodiment, the position of the signal point having the greatest signal intensity is marked by dynamically showing a particular sign on the compass 20. For example, when in use, the mobile phone is moved until the zero position of the compass 20 is overlapped by the sign. The current position of the mobile phone is now in the best communication position.

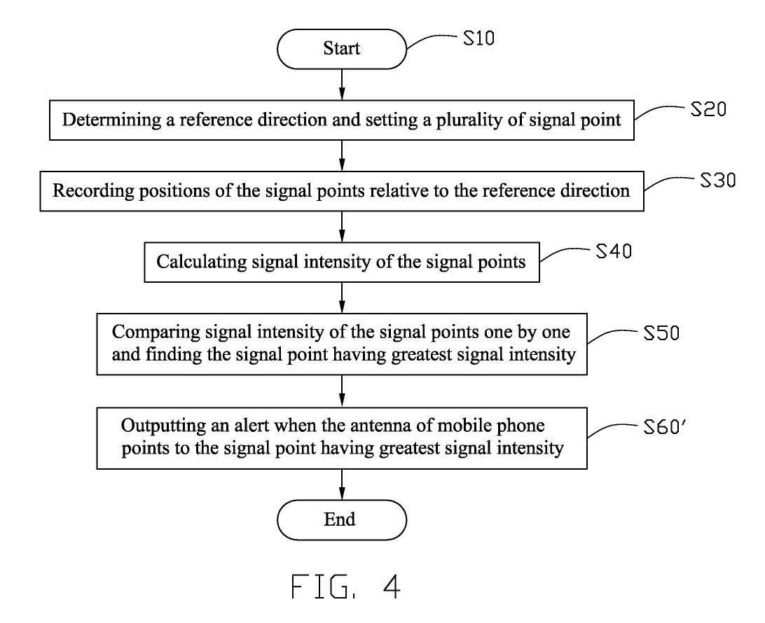

In another embodiment, as step S60′ shown in FIG. 4, the marking unit 67 is capable of controlling a speaker of the mobile phone 10 to output an alert when the antenna of the mobile phone 10 points to the signal point having the greatest signal intensity.

It is to be understood, however, that even though numerous characteristics and advantages of the embodiments have been set forth in the foregoing description, together with details of the structure and function, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A signal intensity indicating method for a mobile phone, the method comprising:
assigning a plurality of signal points equidistantly around a circle;
recording a position of each signal point while rotating the mobile phone;
calculating a signal intensity of each signal point when an antenna of the mobile phone points to a direction consistent with the signal point; and
comparing the signal intensities corresponding to the signal points to determine a signal point having the greatest signal intensity and recording the position of the signal point.

2. The method as described in claim 1, further comprising determining a reference direction and positioning the signal points relative to the reference direction.

3. The method as described in claim 2, further comprising marking the position of the signal point having greatest signal intensity relative to the reference direction after comparing the signal intensities.

4. The method as described in claim 3, wherein the position of the signal point having the greatest intensity is marked by showing a particular sign on the mobile phone.

5. The method as described in claim 1, wherein a speaker of the mobile phone outputs an alert when the antenna of the mobile phone rotates to an orientation consistent with the signal point having the greatest signal intensity.

6. A signal intensity indicating system for a mobile phone, the system comprising:
a signal point collecting unit configured for recording positions of a plurality of signal points equidistantly around a circle;
a signal intensity calculating unit configured for calculating a signal intensity when an antenna of the mobile phone for receiving signals moves to a direction consistent with the signal points;
a signal intensity comparing unit configured for comparing the signal intensity corresponding to the signal points and determining the position of the signal point having a greatest signal intensity; and
a marking unit configured for identifying the signal point having the greatest signal intensity and informing users.

7. The system as described in claim 6, further comprising a compass positioned on the mobile phone with a plurality of points equidistantly around a circle, and a pointer configured to indicate a reference direction and identify the mobile phone position relative to the reference direction.

8. The system as described in claim 6, wherein one of the points, overlapped by the compass when the antenna of the mobile phone points to the reference direction, is set as a zero position.

9. The system as described in claim 6, wherein the marking unit is configured to show a sign on the compass indicating the orientation of the signal point having the greatest signal intensity.

10. The system as described in claim 6, wherein the marking unit is configured to control a speaker of the mobile phone to output an alert when the antenna of the mobile phone points to a direction consistent with the signal point having the greatest signal intensity.
